(19) United States
(12) Patent Application Publication
(10) Pub. No.: US 2013/0243408 A1
(43) Pub. Date: Sep. 19, 2013

(54) VIDEO RECORDING SYSTEM

(71) Applicants: TIBBETTS L. ANTHONY, SEATTLE, WA (US); BARHAM W. NEILL, SEATTLE, WA (US)

(72) Inventors: TIBBETTS L. ANTHONY, SEATTLE, WA (US); BARHAM W. NEILL, SEATTLE, WA (US)

(73) Assignee: CINEGENIX LLC, Seattle, WA (US)

(21) Appl. No.: 13/612,474

(22) Filed: Sep. 12, 2012

Related U.S. Application Data
(60) Provisional application No. 61/533,940, filed on Sep. 13, 2011.

(51) Int. Cl. H04N 5/91

(52) U.S. Cl. CPC H04N 5/91
USPC 386/353

(57) ABSTRACT

Video recording devices, computer readable media, methods, and User Interfaces (UI) are disclosed. An example video recording device may comprise a mobile device equipped with one or more video app modules. The video app modules may be configured to provide any of a variety of useful functions and features described herein.

### CROSS REFERENCE TO RELATED APPLICATIONS

Priority is claimed to U.S. Provisional Application No. 61/533,940, entitled “Video Recording System”, filed Sep. 13, 2011, which is incorporated by reference.

### BACKGROUND

Video production technologies have changed dramatically in recent years. Digital cameras have taken the place of many film cameras, and digital editing techniques have taken the place of film editing. Furthermore, digital cameras capable of capturing high-quality, high-resolution digital video are increasingly included within mobile devices such as iPhone®, Android®, and Windows Mobile® based mobile communications devices. As video technologies have changed, so have the practices and behaviors of filmmakers. There is a need in the industry to continue to support and empower filmmakers to fully leverage emerging video technologies.

### SUMMARY

Video recording devices, computer readable media, methods, and User Interfaces (UI) are disclosed. An example video recording device may comprise a mobile device equipped with one or more video app modules. The video app modules may be configured to provide any of a variety of useful functions and features described herein.

### BRIEF DESCRIPTION OF THE DRAWINGS

FIG. 1 illustrates an example video recording device.

FIG. 2 illustrates an example video app User Interface (UI).

FIG. 3 illustrates example states of a dynamic admin control within the UI of FIG. 2.

FIG. 4 illustrates another example video app UI.

FIG. 5 illustrates another example video app UI.

FIG. 6 illustrates another example video app UI.

FIG. 7 illustrates an example UI comprising a Frames Per Second (FPS) settings control configured for user selection of a FPS setting.

FIG. 8 illustrates an example UI comprising multiple FPS settings controls.

FIG. 9 illustrates an example UI comprising zoom controls and a translucent/disappearing control bar.

### DETAILED DESCRIPTION

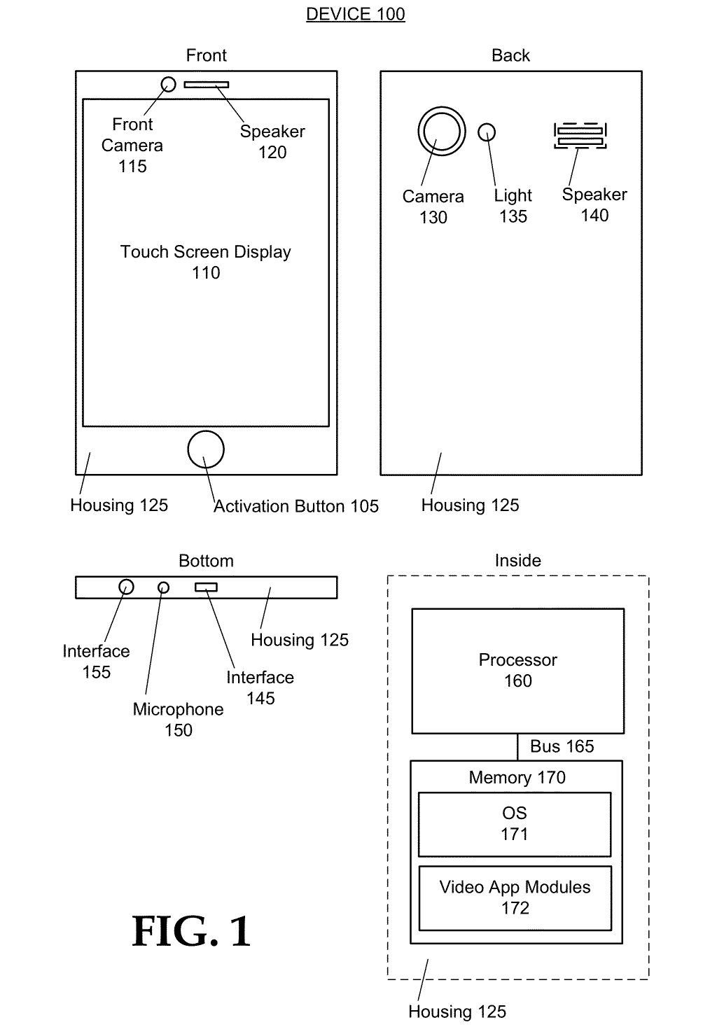

FIG. 1 illustrates an example video recording device in accordance with some embodiments of this disclosure. FIG. 1 includes a front view, back view, bottom view, and internal view of a device 100. The device 100 may take the form of a mobile device such as a smart phone. Device 100 comprises an activation button 105, touch screen display 110, front camera 115, speaker 120, housing 125, camera 130, light 135, speaker 140, interface 145, microphone 150, interface 155, processor 160, bus 165, and memory 170. Memory 170 includes an Operating System (OS) 171 and video app modules 172.

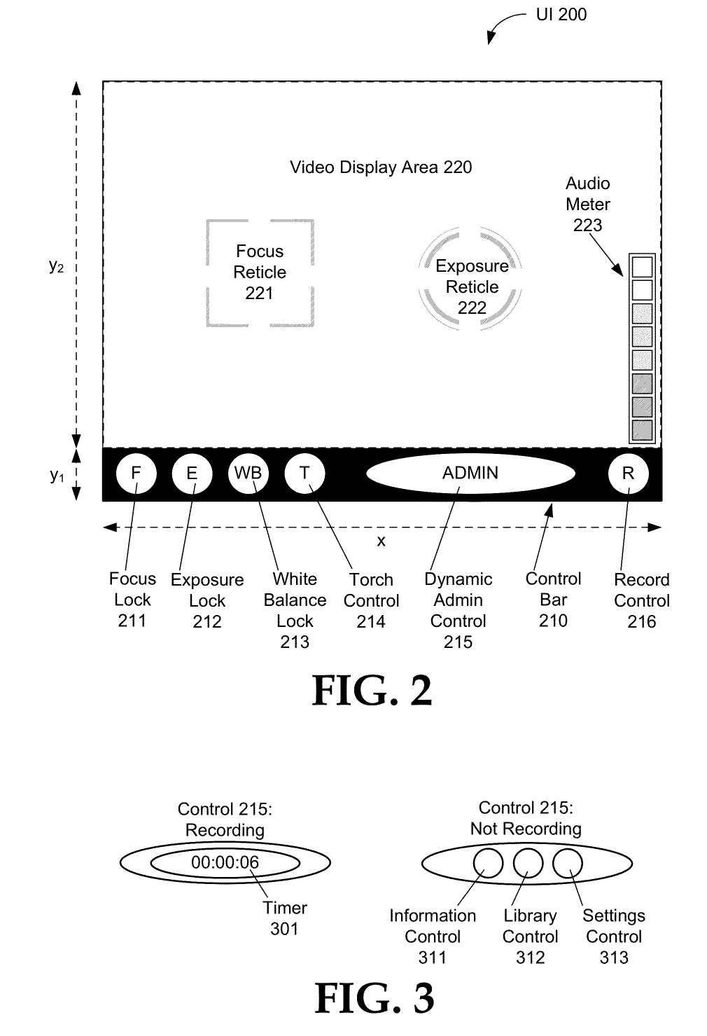

In some embodiments, the video app modules 172 may be configured to produce video app UI on the display 110 in accordance with FIG. 2-FIG. 6. The video app modules 172 may also be configured to cause the device 100 to execute instructions received via the video app UI. It should be appreciated that FIG. 1 therefore illustrates a video recording device 100 as well as a computer readable medium 170 having computer executable instructions configured according to the video app modules 172 described herein. When the device 100 carries out the instructions included in the computer readable medium 170, the device 100 thereby carries out various methods described herein.

It will be appreciated that the device 100 may take the form of any computing device and is not limited to the form of a mobile device. Also, device 100 may include any number of additional features and configurations.

FIG. 2 illustrates an example video app UI 200. Video app modules 172 may be configured to present a UI such as UI 200 on a display such as touch screen display 110. Video app modules 172 may be configured receive commands from a user via UI 200, and to execute received commands with the device 100. Example UI 200 comprises a control bar 210 and video display area 220. The control bar 210 comprises a focus lock 211, exposure lock 212, white balance lock 213, torch control 214, dynamic admin control 215, and record control 216. The video display area 220 may be configured to display video from a camera, e.g., camera 130, and may comprise overlays including a focus reticle 221, exposure reticle 222, and audio meter 223. UI 200 may have a width (x) and a height (y₁+y₂), where y₁ is the height of the control bar 210 and y₂ is the height of the video display area 210.

In some embodiments, the UI 200 may be arranged to occupy the entire display 110. For example, the width (x) of the UI 200 may substantially equal the height of the display 110, as illustrated in FIG. 1, and the height (y₁+y₂) of the UI 200 may substantially equal the width of the display 110, as illustrated in FIG. 1.

In some embodiments, the UI 200 may be arranged according to one or more desired aspect ratios for the video display area 220, and the video app modules 172 may be configured to record video in a same aspect ratio as presented in the video display area 220. The height of the control bar (y₁) may be configured so that the aspect ratio of the video display area (x:y₂) equals a desired aspect ratio, such as 4:3, 16:9, and 2.35:1, or any other desired aspect ratio. Some aspect ratios may comprise any aspect ratio between 2.18:1 and 2.4:1, inclusive, such as, for example an aspect ratio of 2.4:1.

In some embodiments, the video app modules 172 may be configured to adjust to different sizes of display 110 as may be encountered on different devices. For example, video app modules 172 may be configured to determine a display 110 dimension, and calculate a height (or other dimension) of the video display area 220 using the display dimension and solving for the video display area height using a desired aspect ratio. The height of the control bar 210 may then be calculated by subtracting the video display area height from the other of the display 110 dimensions. Video app modules 172 may optionally perform this operation at the time of installation of the video app modules 172 on a particular device or “on the fly” each time the video app modules 172 are loaded.

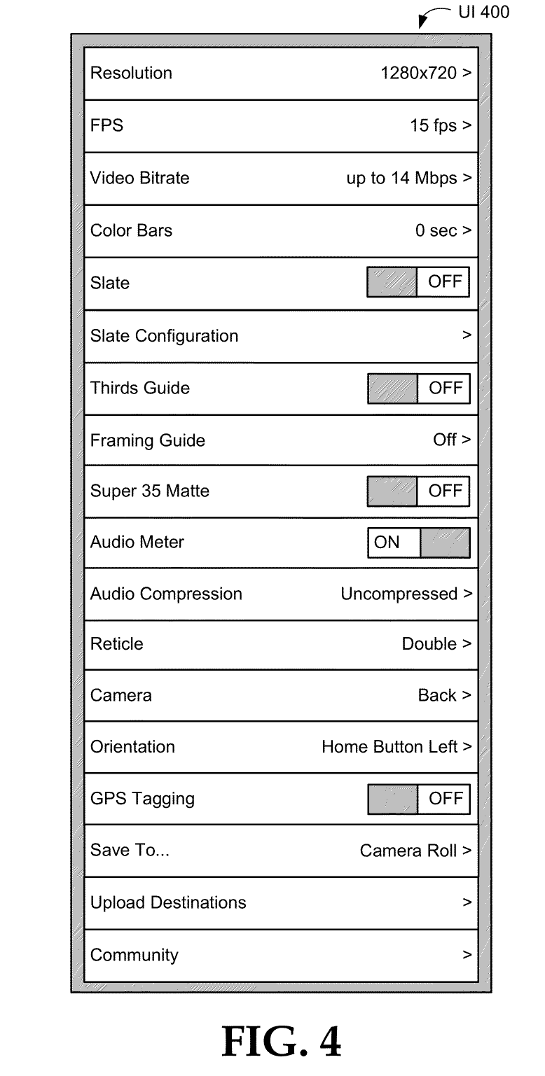

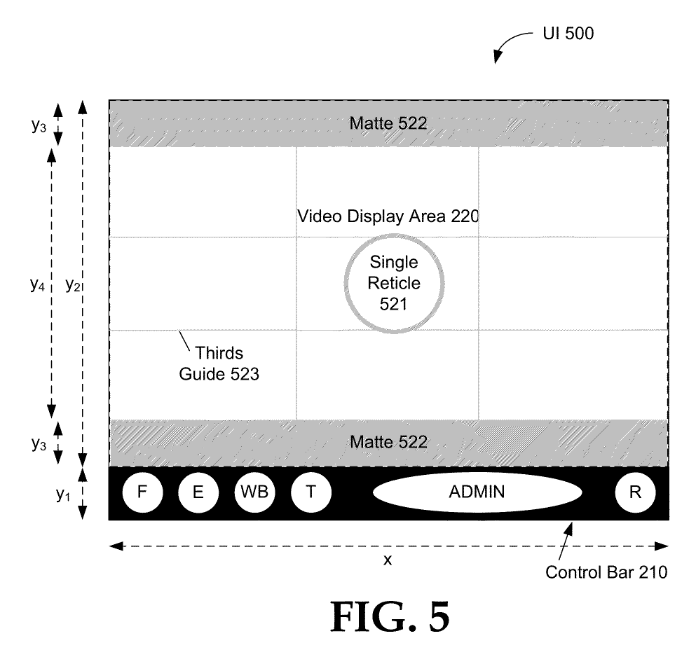

In response to a selection of a different aspect ratio, e.g., a selection of 2.35:1 from a UI 400, as described in connection with FIG. 4, the video app modules 172 may be configured to modify the height of the video display area 220 and/or control bar 210 in the UI 200 to produce the desired different aspect ratio in the video display area 220. In some embodiments, selected alternate aspect ratios may be produced within the video display area 220 through the use of a matte 522 as described in connection with FIG. 5. In some embodiments, the height of the control bar (y₁) in the UI 200 may be constant, regardless of selected aspect ratio, and may correspond to a first aspect ratio. A matte 522 may be used to achieve a video display area 220 with any selected different aspect ratios.

In some embodiments, the UI 200 may be arranged with the control bar 210 underneath the video display area 220, as shown. In this position, the control bar 210 may be accessed with one or both thumbs as a user holds the device 100, allowing ergonomic control as well as minimizing unwanted movement of the device 100 while video recording is underway. Moreover, the specific layout of the control bar 210, with the focus, exposure, and white balance locks 211-213 and torch control 214 at the far left, the admin control 215 in the middle, and the record control 216 at the far right, allows for efficient in-shoot access to controls. It will be appreciated that modifications to the layout of the control bar 210 are possible. For example, in some embodiments, the layout of the control bar 210 may be a mirror image of that shown in FIG. 2, e.g., the position of the record control 216 may be at the far left, the admin control 215 may remain in the middle, and the position of the focus, exposure, and white balance locks 211-213 and torch control 214 may be at the far right.

In some embodiments, the video app modules 172 may be configured to respond to selection of the focus, exposure, or white balance controls 211, 212, 213 by alternately locking and unlocking a focus, exposure, or white balance setting applied to the video display area 220, as well as to any corresponding recorded video. Locking the focus, exposure, or white balance may comprise calculating a focus, exposure, or white balance setting from an image in the display area 220 when the corresponding lock control 211, 212, or 213 is set, and thereafter applying the calculated setting to video subsequently displayed in the display area 220, and corresponding subsequently recorded video, until the corresponding lock control 211, 212, or 213 is released.

In some embodiments, the video app modules 172 may be configured to calculate white balance settings using sampled properties from the full frame of the video display area 220. The video app modules 172 may be configured to calculate focus and/or exposure settings in one or more of three separate modes. In a full frame mode, focus and/or exposure settings may be calculated using sampled properties from the full frame of the video display area 220.

In a single reticle mode, focus and/or exposure settings may be calculated using sampled properties from within a single reticle, such as reticle 521 illustrated in FIG. 5. The single reticle 521 may optionally be a multifunction reticle used for both focus and exposure setting calculations. The single reticle 521 may also optionally be a fixed position reticle, having, e.g., a fixed position in the center of the video display area 220. In the case of a fixed position reticle, desired properties within the reticle may be achieved by aiming the camera/reticle at an object having the desired properties, e.g., at a dark or bright object, or at an object that is close or far away. The single reticle 521 may also optionally be movable within the video display area 220 in some embodiments.

In a double reticle mode, focus settings may be calculated using sampled properties from within a dedicated focus reticle 221, and exposure settings may be calculated using sampled properties from within a dedicated exposure reticle 222, as illustrated in FIG. 2. Each dedicated reticle 221, 222 may optionally be moveable within the video display area 220, e.g., by setting a new reticle position based on received reticle repositioning information. Reticle repositioning information may be received, for example, via a user touching (or otherwise selecting) and dragging a reticle 221, 222 to a desired new position within the video display area 220.

Methods for locking focus and/or exposure may therefore include, for example: displaying a UI such as UI 200 or UI 500 comprising a focus and/or exposure reticle 221, 222, or 521, and separate focus and/or exposure lock controls 211, 212; optionally receiving repositioning input for repositioning the focus and/or exposure reticle 221, 222, or 521; receiving a lock command via the separate focus and/or exposure lock control 211, 212; calculating a focus and/or exposure setting using image properties within the focus and/or exposure reticle 221, 222, or 521; and subsequently applying the focus and/or exposure setting within the video display area 220, as well as for any recorded video, until the focus and/or exposure lock is released via the separate focus and/or exposure lock control 211, 212.

FIG. 3 illustrates example states of a dynamic admin control 215 within the UI 200 of FIG. 2. Two states are shown, including a “recording” state and a “not recording” state. Video app modules 172 may be configured to display the dynamic admin control 215 in the recording state when a recording session is in progress, and video app modules 172 may be configured to display the dynamic admin control 215 in the not recording state when a recording session is not in progress. In the recording state, the dynamic admin control 215 may display a timer 301, configured to measure elapsed time associated with a current record session. In the not recording state, the dynamic admin control 215 may display an information control 311, a library control 312, and/or a settings control 313.

Video app modules 172 may be configured to respond to a received selection of the information control 311 by providing text based app functionality assistance. For example, video app modules 172 may be configured to respond to a received selection of the information control 311 by providing a UI comprising a list of the various controls 211-216 along with descriptions of the operations of the controls 211-216.

Video app modules 172 may be configured to respond to a received selection of the library control 312 by presenting a UI configured for navigating a library of previously recorded video files. The video app modules 172 may be configured to place a video file in the library upon completing a video recording session.

Video app modules 172 may be configured to respond to a received selection of the settings control 313 by presenting a UI configured for managing desired video app settings. An example settings UI is discussed in connection with FIG. 4.

FIG. 4 illustrates another example video app UI. Video app modules 172 may be configured to present a UI such as UI 400 on a display such as touch screen display 110. Video app modules 172 may be configured receive commands from a user via UI 400, and to execute received commands with the device 100. Example UI 400 comprises a menu including a plurality of setting controls. The illustrated example setting controls include a resolution control, a Frames Per Second (FPS) control, a video bit rate control, a color bars control, a slate control, a slate configuration control, a thirds guide control, a framing guide control, a super 35 matte control, an audio meter control, an audio compression control, a reticle control, a camera control, an orientation control, a Global Positioning System (GPS) tagging control, a save to control, an upload destinations control, and a community control.

Video app modules 172 may be configured to respond to a received selection of the resolution control by displaying a UI comprising a list of selectable resolution settings. The list of selectable resolution settings may include, e.g., 1280×720, 640×480, and 480×320. In response to a user selection of a resolution setting from the list of selectable resolution settings, the video app modules 172 may be configured to record video, in a subsequent video recording session initiated from a UI such as UI 200 and/or UI 500, in the selected resolution.

Video app modules 172 may be configured to respond to a received selection of the FPS control by displaying a UI comprising a list of selectable FPS settings. In some embodiments, the list of selectable FPS settings may include a plurality of FPS settings within a predefined range. The plurality of FPS settings may be contiguously variable by including every whole number within the predefined range, or may include some but not all of the possible FPS settings in the range. In some embodiments, the plurality of FPS settings may include a contiguously variable block of FPS settings within a predefined range, as well as one or more additional FPS settings that are not contiguous with the block. For example, in some embodiments, the list of selectable FPS settings may include, e.g., 30 settings, in one-FPS increments, in a contiguous block ranging from 1-30 FPS. In some embodiments, the list of selectable FPS settings may include, e.g., 25 settings, in one-FPS increments, ranging in a contiguous block from 1-25 FPS, plus an additional 30 FPS setting (which is outside the contiguous block), for a total of 26 FPS settings in the range of 1-30 FPS. Other combinations of FPS settings are also possible as will be appreciated with the benefit of this disclosure.

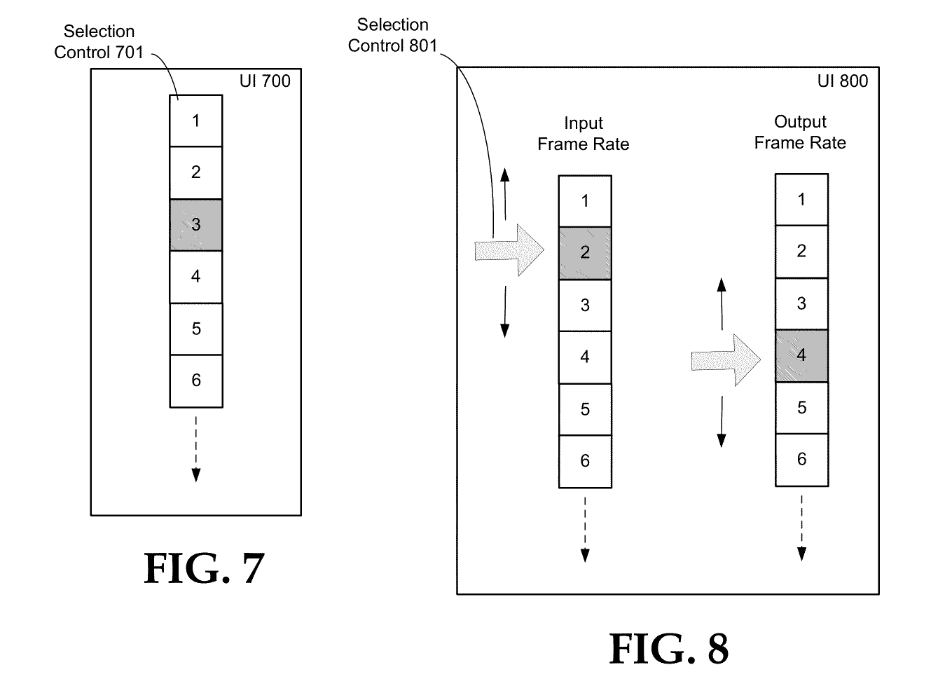

For example, FIG. 7 illustrates an example UI 700 comprising a FPS settings control configured for user selection of a FPS setting from a plurality of FPS settings, wherein the plurality of FPS settings includes at least one block of two or more contiguous FPS settings. The user may select an FPS setting by touching a selection control, such as 701, corresponding to a desired FPS setting. The dotted arrow shows that additional FPS settings (for settings above 6 FPS) may be included. In some embodiments, FPS settings selectable in UI such as 700 may include 24 FPS, 25 FPS, and 30 FPS.

In another example, FIG. 8 illustrates an example UI 800 comprising multiple FPS settings controls. UI 800 comprises an input frame rate control and an output frame rate control. Each control includes an example selection control 801, in this case illustrated as a slidable arrow pointing to the selected FPS. The input frame rate control may set FPS for recorded video, e.g. similar to the control illustrated in UI 700, while the output frame rate control may set FPS for video playback.

In response to a user selection of a FPS setting from the list of selectable FPS settings, the video app modules 172 may be configured to apply the FPS setting to recorded video during subsequent video record sessions entered from UI 200 and/or UI 500.

Video app modules 172 may be configured to respond to a received selection of the video bit rate control by displaying a UI comprising a list of selectable video bit rate settings. The list of selectable video bit rate settings may include, e.g., a high-quality setting, a medium setting, and an economy setting. For example, settings may include an “up to 14 megabits per second (Mbps)” high-quality setting, an “up to 11 Mbps” medium setting, and/or an “up to 8 Mbps” economy setting. In response to a user selection of a video bit rate setting from the list of selectable video bit rate settings, the video app modules 172 may be configured to record video, in a subsequent video recording session initiated from a UI such as UI 200 and/or UI 500, in the selected video bit rate.

Video app modules 172 may be configured to respond to a received selection of the color bars control by prepending recorded video files captured with device 100 with broadcast standard color bars. Color bars may be prepended to a video file for any selected amount of time, e.g., for a duration of from 1-15 seconds.

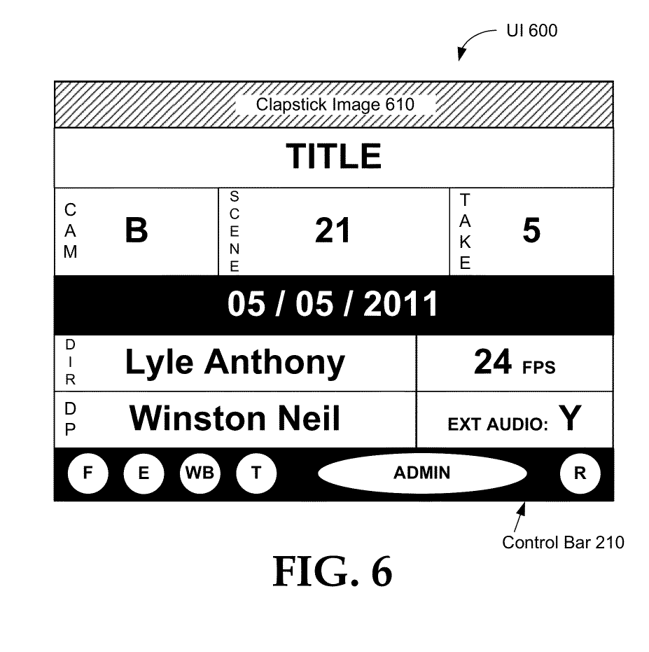

Video app modules 172 may be configured to provide a selectable “on/off” switch in a slate control, as shown. Video app modules 172 may respond to user input to place the slate in an “on” state by configuring video recording UI such as UI 200 and/or UI 500 to deploy a slate feature, as described in connection with FIG. 6. Video app modules 172 may respond to user input to place the slate in an “off” state by removing the slate feature from video recording UI.

Video app modules 172 may also be configured to provide a slate configuration control. In response to a received selection of the slate configuration control, video app modules 172 may display one or more additional UI configured to receive digital slate information, such as disclosed in connection with FIG. 6.

Video app modules 172 may be configured to provide a selectable “on/off” switch in a thirds guide control, as shown. Video app modules 172 may respond to user input to place the thirds guide in an “on” state by displaying a thirds guide in a video recording UI, for example a thirds guide 523 as shown in UI 500 in FIG. 5. Video app modules 172 may respond to user input to place the thirds guide in an “off” state by removing the thirds guide from the video recording UI.

Video app modules 172 may be configured to respond to a received selection of the framing guide control by displaying a UI comprising a list of selectable framing guide settings. The list of selectable framing guide settings may include, e.g., “off”, “2.35:1”, “4:3”, “16:9”, and/or any other desired aspect ratio. In response to a user selection of a framing guide setting from a UI comprising a list of selectable framing guide settings, the video app modules 172 may be configured to display a framing guide in a video display area 220 of a UI such as UI 200. The framing guide may comprise, e.g., a partially transparent/translucent frame and/or framing lines surrounding at least a portion of the video display area 220. The portion of the video display area 220 inside the framing guide may be referred to herein as the framed video display area, while the regions that overlap the frame provided by the framing guide may be referred to herein as the border regions. The framed video display area may comprise an aspect ratio corresponding to a selected framing guide setting. In some embodiments, when a framing guide is displayed in the UI 200, the video app modules 172 may be configured to record only video from the framed video display area.

Video app modules 172 may be configured to provide a selectable “on/off” switch in a matte control, such as the super 35 matte control as shown. Video app modules 172 may respond to user input to place the matte control in an “on” state by displaying a matte in a video recording UI, for example a matte 522 as shown in UI 500 in FIG. 5. Video app modules 172 may respond to user input to place the matte control in an “off” state by removing the matte from the video recording UI. Alternatively, video app modules 172 may be configured to provide a matte control comprising a list of selectable matte settings, e.g., in embodiments that comprise more than two matte settings.

The matte 522 may be applied to one or more of the top, bottom, right and/or left edges of a video display area 220, and may be configured to produce video display area dimensions (inside the matte area) that correspond to the dimensions of a selected matte control aspect ratio. Video app modules 172 may also be configured to record video during a subsequent video recording session with video file dimensions that are sized according to the dimensions of the selected matte control aspect ratio. In some embodiments, opaque black matte may be written frame by frame to a recorded video file, to produce a recorded video file comprising a matte 522 as displayed in the UI 500.

Video app modules 172 may be configured to provide a selectable “on/off” switch in an audio meter control, as shown. Video app modules 172 may respond to user input to place the audio meter in an “on” state by displaying an audio meter in a video recording UI, for example an audio meter 223 as shown in UI 200 in FIG. 2. Video app modules 172 may respond to user input to place the audio meter in an “off” state by removing the audio meter from the video recording UI.

Video app modules 172 may be configured to respond to a received selection of the audio compression control by displaying a UI comprising a list of selectable audio compression settings. The list of selectable audio compression settings may include, e.g., compressed and uncompressed. Any number of additional settings may specify audio compression rates. In response to a user selection of an audio compression setting from the list of selectable audio compression settings, the video app modules 172 may be configured to record audio, in a subsequent video recording session initiated from a UI such as UI 200 and/or UI 500, in the selected audio compression setting.

Video app modules 172 may be configured to respond to a received selection of the reticle control by displaying a UI comprising a list of selectable reticle settings. The list of selectable reticle settings may include, e.g., one or more of a “full frame”, “single”, and/or “double” reticle setting. In response to a user selection of a full frame reticle setting from the list of selectable reticle settings, the video app modules 172 may be configured to modify a UI 200 to not display reticles, and to calculate focus and exposure settings in full frame mode. In response to a user selection of a single reticle setting from the list of selectable reticle settings, the video app modules 172 may be configured to modify a UI 200 to display a single reticle 521, and to calculate focus and exposure settings in single reticle mode. In response to a user selection of a double reticle setting from the list of selectable reticle settings, the video app modules 172 may be configured to modify a UI 200 to display two reticles 221, 222, and to calculate focus and exposure settings in double reticle mode.

Video app modules 172 may be configured to respond to a received selection of the camera control by displaying a UI comprising a list of selectable camera settings. The list of selectable camera settings may include, e.g., front camera and back camera. In response to a user selection of a camera setting from the list of selectable audio compression settings, the video app modules 172 may be configured to record video, in a subsequent video recording session initiated from a UI such as UI 200 and/or UI 500, from the selected camera, such as the front camera 115 or back camera 130 illustrated in FIG. 1.

Video app modules 172 may be configured to respond to a received selection of the orientation control by displaying a UI comprising a list of selectable UI orientation settings. The list of selectable UI orientation settings may include, e.g., auto-rotate, home button left, and home button right orientation settings. In response to a user selection of a UI orientation setting from the list of selectable UI orientation settings, the video app modules 172 may be configured to display a UI such as UI 200 and/or UI 500, in an orientation corresponding to the selected UI orientation setting, and the video app modules 172 may be configured to record video files in an orientation corresponding to the selected UI orientation setting.

In an example “home button left” orientation setting, a UI 200 may be displayed on a display 110 in an orientation in which the bottom of the device 100 is to the left of the UI 200, when viewed as illustrated in FIG. 2, regardless of whether the device 100 is re-oriented, and regardless of whether a video recording session is (or is not) underway. In an example “home button right” orientation setting, a UI 200 may be displayed on a display 110 in an orientation in which the bottom of the device 100 is to the right of the UI 200, when viewed as illustrated in FIG. 2, regardless of whether the device 100 is re-oriented, and regardless of whether a video recording session is (or is not) underway. Video that is recorded while in the “home button left” and “home button right” orientation settings may be oriented so that the recorded video is “right-side up” when the UI 200 is right-side up, and “upside down” when the UI 200 is upside down. In other words, for a given device 100 orientation, the orientation of recorded video made during a video recording session while in the home button left orientation setting is 180 degrees different from the orientation of recorded video made during a video recording session while in the home button right orientation setting.

In some embodiments, the auto-rotate orientation setting may be the default orientation setting. In an example auto-rotate orientation setting, when there is no active video recording session underway, the orientation of a UI 200 may be auto-rotated so that the UI 200 is always as close to “right side up” as possible. In other words, the orientation of a UI 200 may be auto-rotated between a home button left orientation setting and a home button right orientation setting, in response to reorientation of the device 100. In some embodiments, once a video recording session is initiated, the orientation of the UI 200 may be locked in the current orientation, e.g., either home button left or home button right, for the duration of the video recording session.

Video app modules 172 may be configured to provide a selectable “on/off” switch in a Global Positioning System (GPS) tagging control, as shown. Video app modules 172 may respond to user input to place the GPS tagging control in an “on” state by storing GPS location information associated with recorded video files. Video app modules 172 may respond to user input to place the GPS tagging control in an “off” state by not storing GPS location information associated with recorded video files.

Video app modules 172 may be configured to respond to a received selection of the save to control by displaying a UI comprising a list of selectable storage locations for recorded video files. The list of selectable storage locations may include, e.g., various locations in a memory of a device 100 such as illustrated in FIG. 1. Network storage locations and/or external device or Universal Serial Bus storage locations may also be selectable in some embodiments. In response to a user selection of a storage location from the list of selectable storage locations settings, the video app modules 172 may be configured to store recorded video, in a subsequent video recording session initiated from a UI such as UI 200 and/or UI 500 in the selected storage location.

Video app modules 172 may be configured to respond to a received selection of the upload destinations control by displaying a UI comprising a list of selectable network destinations for upload of recorded video files. The UI may further comprise upload destination configuration controls for adding/deleting upload destinations.

Video app modules 172 may be configured to respond to a received selection of the community control by displaying a UI comprising one or more controls for sharing video, comments and reviews, and/or one or more controls for accessing internet-based discussion, social networking, or other information-sharing destinations. For example, in some embodiments, a UI comprising a field for posting tips, advice, or experiences relating to the use of the use of a video recording system may be displayed. The UI may be configured to send shared information to a predetermined information-sharing destination.

FIG. 5 illustrates another example video app UI. Video app modules 172 may be configured to present a UI such as UI 500 on a display such as touch screen display 110. Video app modules 172 may be configured to receive commands from a user via UI 500, and to execute received commands with the device 100. Example UI 500 comprises a video display area 220 and control bar 210 as illustrated in FIG. 2. In FIG. 5, video display area 220 comprises matte sections 522, a single reticle 521, and a thirds guide 523.

As previously described, in some embodiments the single reticle 521 may be used for sampling properties used in focus and/or exposure calculations. In some embodiments, the single reticle 521 may comprise a multifunction reticle, used for sampling properties for focus and exposure setting calculations. Video app modules 172 may be configured to calculate a focus setting using sampled properties from the single reticle 521 in response to a received selection of a focus lock command via the focus lock control 211. Video app modules 172 may be configured to calculate an exposure setting using sampled properties from the single reticle 521 in response to a received selection of an exposure lock command via the exposure lock 212. Also, in some embodiments, the single reticle 521 may have a fixed position within the video display area 220. Embodiments in which the single reticle 521 may be repositioned within the video display area 220 are also possible as will be appreciated with the benefit of this disclosure.

In some embodiments, matte sections 522 may overlap one or more portions of the video display area 220, changing the aspect ratio of the video display area 220. For example, the illustrated matte sections 522 shorten the height of the video display area 220 by the amounts y₃, leaving a video display area height of y₄. In some embodiments, the video display area may have a default aspect ratio (without the matte sections 522) of 4:3, and super 35 (2.35), may be among the aspect ratios available by application of a matte setting. In some embodiments, the matte sections 522 may be opaque. Recorded video files generated from video record sessions in which matte sections 522 are deployed may optionally include only video from the non-matte portion of the video display area 220, or may include the matte section(s), depending on desired video file format.

In some embodiments, the thirds guide 523 may provide horizontal and vertical lines across the video display area 220, dividing the video display area 220 into equal thirds vertically and horizontally. When the aspect ratio of the video display area 220 is changed, e.g. by application of matte sections 522 or a framing guide, the video app modules 172 may be configured to reposition the lines of the thirds guide 523 to maintain equal one-third divisions of the framed/matted video display area 220. The video app modules 172 may be configured to display the thirds guide 523 in the video display area 220, but embodiments may not record the thirds guide 523 in corresponding recorded video files produced during record sessions with UI 500. Similarly, the reticles 221, 222, 521 and audio meter 223 may remain unrecorded in some embodiments.

FIG. 6 illustrates another example video app UI. Video app modules 172 may be configured to present a UI such as UI 600 on a display such as touch screen display 110. Video app modules 172 may be configured receive commands from a user via UI 600, and to execute received commands with the device 100. Example UI 600 comprises a digital slate within the video display area 220 illustrated in FIG. 2, and the control bar 210 illustrated in FIG. 2. The example digital slate comprises a clapstick image 610, and a “chalkboard” section including filming information such as a production title identifier, a camera identifier, a scene identifier, a take identifier, a date identifier, a director identifier, a cinematographer (DP) identifier, a FPS identifier, and an external audio identifier.

When the digital slate setting is set to “on”, e.g., from a menu UI as illustrated in FIG. 4, the video app modules 172 may be configured to automatically prepare and display a digital slate for each video recording session, and to automatically prepend video files produced during each video record session with the corresponding digital slate. In some embodiments, the video app modules 172 may be configured to display a digital slate in the video display area 220 prior to receiving a record command via the record control 216. Video app modules 172 may be configured to respond to receiving a record command by optionally producing a synchronizing flash and audio tone, as described below, and then proceeding to display recorded video from the device camera 130 in the video display area 220 until the end of the recording session.

In some embodiments the video app modules 172 may be configured to generate UI configured to receive digital slate information. Example UI configured to receive digital slate information may include fields for production title identifier, camera identifier, scene identifier, director identifier, a cinematographer (DP) identifier, FPS identifier, and external audio identifier. Received digital slate information may be stored and used to populate the digital slate illustrated in FIG. 6.

Video app modules 172 may be configured to automatically generate certain digital slate information. For example, the date identifier and take identifier may be automatically determined for each digital slate. The date identifier may be the actual date retrieved from the device OS 171, and the take identifier may be determined by incrementing from a previous take number corresponding to a same production and scene identifier.

In some embodiments the video app modules 172 may be configured to generate a synchronizing flash and/or audio tone in video files produced from video record sessions wherein a digital slate setting is set to “on”. For example, video app modules 172 may be configured to generate an entirely white first frame at the start of a recording session. A first frame with any other color or visual marking that is easily identifiable for the purpose of editing and combining video footage may also be used. In some embodiments, video app modules 172 may be configured to cause the device light 135 to flash, to produce a distinctive unusually bright frame.

Video app modules 172 may also be configured to cause the device 100 to generate a distinctive audible tone, e.g. via a device speaker 140, during a first frame of a video record session wherein a digital slate setting is set to “on”. A distinctive tone may otherwise be produced for example by manipulating a generated video file, or by causing some external device to produce the desired tone. The audible tone can be used to align video and audio tracks, e.g., when an external audio recording device is used. Also, the synchronizing flash and/or audio tone may facilitate aligning video and/or audio from multiple cameras.

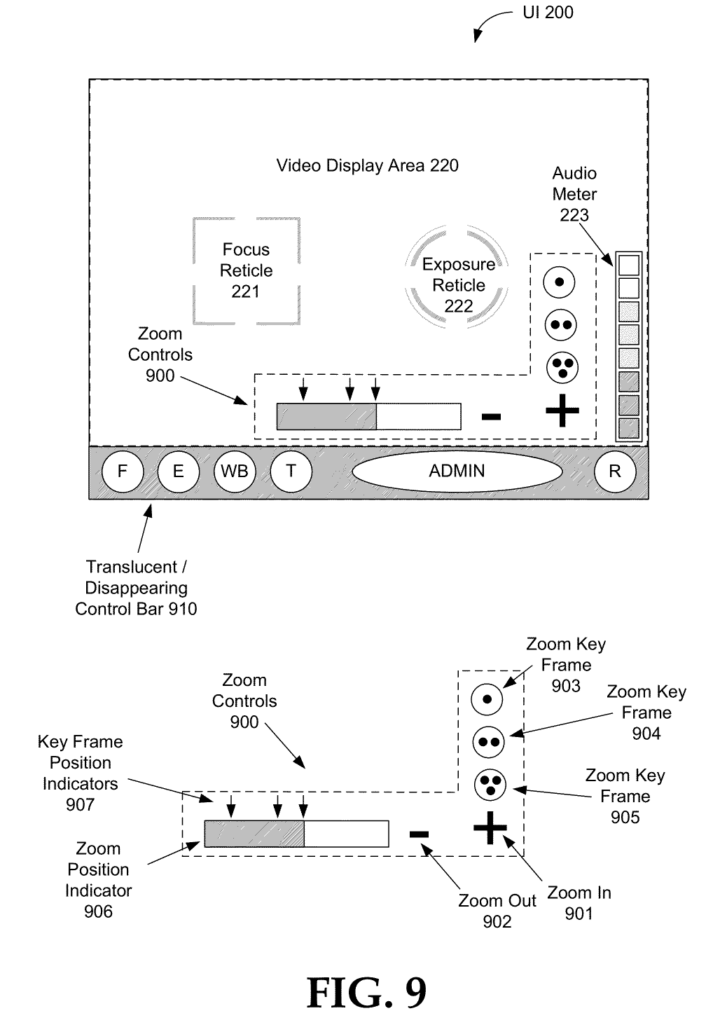

FIG. 9 illustrates an example UI comprising zoom controls and a translucent/disappearing control bar. The UI 200 may be configured with zoom controls 900. Zoom controls 900 may comprise a zoom in control 901, a zoom out control 902, zoom key frame controls 903, 904, and 905, and/or a zoom position indicator 906 with key frame position indicators 907. Zoom in control 901 and zoom out control 902 may control a digital or other zoom, affecting the image displayed in video display area. A current zoom setting may be indicated in zoom position indicator 906, e.g., by the shaded gray area within indicator 906, wherein, for example, a maximum zoom may be indicated by extending the gray bar to the full length of the indicator 906, and minimum zoom may be indicated by shrinking the gray bar to a minimum length and/or disappearance of the gray bar within the indicator 906.

The zoom controls key frame controls 903, 904, and 905 may be user-configurable zoom key frame controls. For example, touching and holding a key frame control while at a particular zoom setting may operate to set or reset the key frame control at the particular zoom setting. A key frame position indicator 907 may be placed over the zoom position indicator 906 to reflect the particular zoom settings selected for each of the key frame controls 903, 904, and 905. The key frame controls 903, 904, and 905 may enable the user to return to zoom settings established for the zoom key frame controls. For example, a single touch on a key frame control may operate to return the device to a zoom setting established for the key frame control.

Translucent/disappearing control bar 910 may be used in some embodiments to maximize the display size of video display area 220 at a given aspect ratio. Translucent/disappearing control bar 910 may be configured to allow video information to show through the control bar 910. Furthermore, the control bar 910 may be configured to substantially disappear during video recording sessions. When the selected aspect ratio matches that of the entire touch screen display, the usage of the touch screen display may be maximized by the use of translucent/disappearing control bar 910. A touch in the video display area 220 may cause translucent/disappearing control bar 910 to reappear for access to video controls.

While various embodiments have been disclosed herein, other aspects and embodiments will be apparent to those skilled in art.

1. A mobile device equipped with a video recording application, comprising:
a processor;
a touch screen display;
a memory; and
a video recording application loaded in the memory and executable by the processor, wherein the video recording application causes the processor to:
display a User Interface (UI) on the touch screen display, wherein the UI is configured to establish video recording settings, wherein the UI comprises one or more UI controls; and the video recording application is configured to respond to user touch interactions with the one or more UI controls;
wherein the one or more UI controls comprise a Frames Per Second (FPS) settings control configured for user selection of a FPS setting from a plurality of FPS settings, wherein the plurality of FPS settings includes at least one block of two or more contiguous FPS settings; and
wherein the video recording application is configured to apply a user selected FPS setting received via the FPS settings control to video recording by the mobile device in at least one video recording session conducted by the video recording application subsequent to the user selection of the FPS setting.

2. A mobile device according to claim 1, wherein the plurality of FPS settings includes a single block of contiguous FPS settings from 1-30 FPS.

3. A mobile device according to claim 1, wherein the plurality of FPS settings includes a block of contiguous FPS settings from 1-25 FPS, and an additional 30 FPS setting.

4. A mobile device according to claim 1, wherein the plurality of FPS settings includes a block of contiguous FPS settings including 24-25 FPS, and an additional 30 FPS setting.

5. A mobile device according to claim 1, wherein the video recording application further causes the processor to display a video recording UI, the video recording UI comprising:
a video display area; and
a control bar along an edge of the video display area, the control bar comprising a focus lock, an exposure lock, and/or a white balance lock.

6. A mobile device according to claim 5, wherein the video recording UI further comprises:
a record control; and
a dynamic administrative control with a first state and a second state, wherein the dynamic administrative control is in the first state during an active video recording session, and wherein the dynamic administrative control is otherwise in the second state.

7. A mobile device according to claim 5, wherein the video display area comprises a single reticle, wherein the video recording application calculates focus using samples from within the single reticle in response to user selection of the focus lock, and wherein the video recording application calculates exposure using samples from within the single reticle in response to user selection of the exposure lock.

8. A mobile device according to claim 7, wherein the single reticle has a fixed position in the center of the video display area.

9. A mobile device according to claim 5, wherein the video display area comprises a default aspect ratio, and wherein the video recording application enables user selection of one or more different aspect ratios.

10. A mobile device according to claim 9, wherein the default aspect ratio or one of the different aspect ratios comprises an aspect ratio between 2.18:1 and 2.4:1, inclusive.

11. The user interface of claim 9, wherein the video recording application is configured to produce the aspect ratio between 2.18:1 and 2.4:1 by applying a matte to a portion of the video recording UI.

12. A mobile device according to claim 9, wherein the default aspect ratio or one of the different aspect ratios comprises an aspect ratio of 2.4:1.

13. A mobile device according to claim 9, wherein the default aspect ratio or one of the different aspect ratios comprises an aspect ratio of 2.35:1.

14. A mobile device according to claim 5, wherein the video display area comprises a focus reticle and a separate exposure reticle.

15. A mobile device according to claim 5, wherein the video recording UI further comprises zoom controls, the zoom controls comprising a plurality of user-configurable zoom key frame controls enabling user return to zoom settings established for the user-configurable zoom key frame controls.

16. A mobile device according to claim 5, wherein the control bar is translucent and wherein the control bar is configured to substantially disappear during the video recording session.

17. A mobile device according to claim 5, wherein FPS settings control comprises an input FPS settings control and an output FPS settings control.

18. A mobile device according to claim 1, wherein the video recording application further causes the processor to display a digital slate on the touch screen display prior to a video recording session with the mobile device, and wherein the video recording application further causes the processor to generate a synchronizing flash on the touch screen display and an audible tone with a mobile device speaker during a first frame of the video recording session.

19. A User Interface (UI) configured to establish video recording settings, comprising:
a UI comprising a display presented on a mobile device touch screen, wherein a video recording application executable by the mobile device is configured to respond to user touch interactions with one or more UI controls presented on the mobile device touch screen;
wherein the one or more UI controls are configured to enable a user to establish video recording settings through the user touch interactions, wherein the video recording settings are applied by the video recording application executable by the mobile device to video recording by the mobile device in at least one video recording session conducted by the video recording application subsequent to the user touch interactions; and
wherein the one or more UI controls comprise a Frames Per Second (FPS) settings control configured for user selection of a FPS setting from a plurality of FPS settings, wherein the plurality of FPS settings includes at least one block of two or more contiguous FPS settings.
